(19) United States
(12) Patent Application Publication
(10) Pub. No.: US 2004/0216361 A1
(43) Pub. Date: Nov. 4, 2004

(54) Fish lure

(76) Inventor: Bedford H. Miller, Napoleon, OH (US)

Correspondence Address: George R. Royer, Suite 416, 316 N. Michigan Street, Toledo, OH, 43624, US

(21) Appl. No.: 10/426,514

(22) Filed: May 1, 2003

(51) Int. Cl. A01K 85/00

(52) U.S. Cl. 43/42.47

(57) ABSTRACT

The subject invention is an improved fish lure which is structured to provide unique movements of the lure when trawled through the water, such lure comprising a fish-shaped body with a hydro-dynamically shaped surface, and a cup-shaped member positioned on the body, with such cup shape having a concave surface facing toward the front of the lure.

### DISCUSSION OF PRIOR ART AND BACKGROUND OF THE INVENTION

This invention relates to fish lures that are structured to resemble a small fish or other waterborne creatures. As such it is an improvement on existing lures for enhancing the movement of a lure through the water.

One of the problems with existing fish lures that are structured to have wiggling movements through the water is that their movement through the water does not sufficiently emulate a small fish stopping and darting about similar to the actual movement of a minnow of other small fish Various attempts have been made to accomplish this result, however, none have been successful in this regard. Accordingly, the subject invention is conceived and structured accordingly and the following are the stated objects of this invention.

### OBJECTS OF THE INVENTION

It is an affect of this invention to provide an improved fish lure to be used for purposes of simulating the movements of a small fish in water.

It is also an object of this invention to provide an improved fish lure;

Another object of this invention is to provide an improved lure for fishing purposes;

Yet another object of this invention is to provide an improved hydro-dynamically structured fish lure;

It is another object of the subject invention to provide a lure which projects air bubbles in greater proliferation from the back of the lure as it travels through the water.

Still another object of the subject invention is to provide an improved lure that provides a more fishlike movement through the water.

Other and further objects of this invention will become apparent from reading of the claims taken in conjunction with the clams.

### DESCRIPTION OF DRAWINGS

FIG. 1 is a side elevational view of the subject invention;

FIG. 1B is a top elevational view of the subject invention;

FIG. 1C is a front elevational view of the subject invention.

### DESCRIPTION OF GENERAL EMBODIMENT AND SUMMARY OF THE INVENTION

The subject invention is an improved fish lure which is structured to provide unique movements of the lure when trolled or pulled through the water, such lure comprising of a fish-shaped body with a hydrodynamically shaped surface, and a cup-shaped member positioned concentrically on the body, with such cup member having a concave surface facing toward the front of the lure.

In summary, the subject invention is an improved fish lure comprising in general of an elongated member, such member being shaped hydrodynamically like a small fish in order to resemble the same. The elongated body of the fish is preferably, but not necessarily rigid and has the usual physical attributes of a conventional fish lure, except for the additional feature of a concave member being affixed symmetrically and concentrically relative to the central longitudinal axis to any part of the body of the lure. More specifically, the lure member incorporating features of this invention has a cup-like member having a frontal surface that is indented or concave and is appended on the front or back of the lure. The center of the concave surface of the cup member is generally aligned along the longitudinal central axis of the longitudinal body of the lure body member and by such latter relationship the outer circumferential peripheral of the cup member will be disposed basically symmetrically to the long axis of the lure body, as seen from a front end elevational view. In some embodiments a similar cup-member can be affixed along any part of the body in the form of a circular or circumferential flange like member where it is inclined forward to provide the same physical effect as a frontally disposed cup and wherein the cup member has a plurality of small openings therein to function to pass small streams of water therethrough as the lure passes through the water to create a trailing bubble effect.

This cup like member functions particularly to partially interfere with the hydro-dynamic flow over the longitudinal body of the lure to create a popping like noise as the lure passes through the water and to also create a splashing, as well as jerking motion, involving lateral movements or movements as the lure moves in the water. These latter described effects are intended to emulate the movement, splashing and darting, as well as the lateral movements, of a small fish as it move in darting fashion through the water. This more realistic emulation of such movement thereby cause the larger fish to be more readily attracted to the lure.

In summary, the subject invention is an improved fish lure comprising in general an elongated member which is structured to provide unique movements when trawled through the water, such lure comprising of a fish-shaped body with an aerodynamic surface with a cup-shaped member positioned on the body, with such cup shape having a concave surface facing toward the front of the head of the lure body.

### DESCRIPTION OF PREFERRED EMBODIMENT

In describing the preferred embodiment of the subject invention, one preferred embodiment will be set forth However, a description of one limited embodiment of the subject invention will not be considered as limiting the scope of the subject invention, as set forth in the claims, to only one such embodiment.

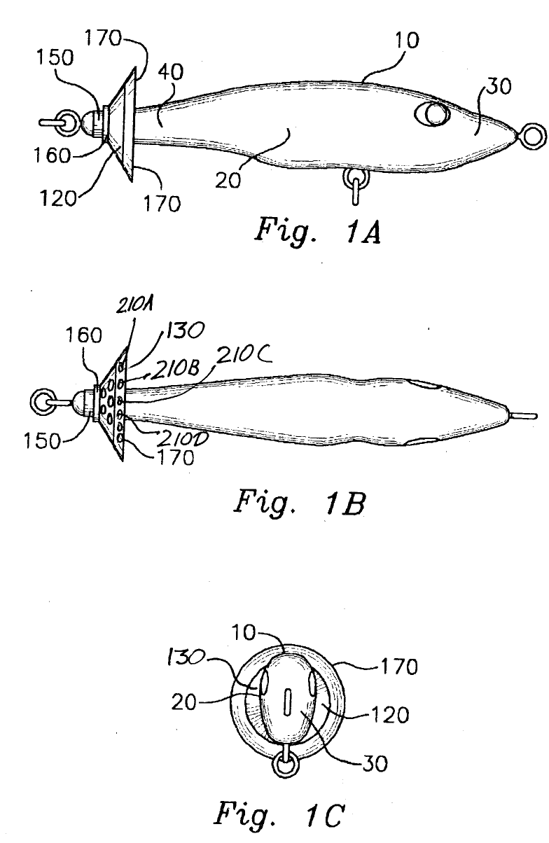

Referring now to the drawings in which a preferred embodiment is shown, seen in FIG. 1 is a generally conventionally shaped lure 10 possessing features of the preferred embodiment of the invention herein As seen, lure 10 has a body 20 which resembles the body of a fish, with the body 20 being elongated and having an imaginary longitudinally central axis A-A extending from front to back.

This elongated body 20 lure 10 has a head front end 30 as well as posterior end 40. The main shank 45 of the body 20 is disposed between the head end 30 and the posterior end 40 and the body is generally, but not necessarily, thicker than the front or posterior ends of the body, as can be seen in the drawings.

The body 20 of the lure has an upper hydrodynamic surface 70 and a relatively flat lower surface 80, and when viewed from the side elevational view of FIG. 1, the body resembles an air foil. The head end 30 is relatively pointed and leading edge of the air foil shape. As further can be seen in the drawings, the lure 10 has one or more attached hooked members 90A, 90B, 90C, and 90D, which are attached generally to the bottom surface 80 of the body 20 in a dangling manner, or on other portions of the lure.

As can be further seen in the drawings, and shown in FIG. 1, affixed to the posterior end of the lure body 20 is a cup shaped member 120 that is intended to partially inhibit and affect the hydrodynamic flow of water over the lure as it passes through the water. This cup shaped member 120 has a posterior surface 125 and a frontal surface 130 that is basically cup shaped, thus providing a concave formed surface 130, facing the front end 30 of the lure body with the deepest point being the center 150 of the front surface as seen. The cup shaped member 120 thus has a concave or indented frontal projection with the center 150 of the concave front surface 130 being affixed concentrically about the lure's central longitudinal axis at or near the tail of the lure body 20. By this arrangement, the frontal surface 130 of the cup member faces towards the head end 30 of the lure, while the posterior convex surface 125 of the cup shaped member faces in a posterior direction towards the posterior end 40 of the lure.

As stated it is preferable that the cup shaped member 130 be symmetrically aligned along the longitudinal central axis A-A of the lure body so that the outer circumferential edge 170 of the cup member extends evenly out from the outer surface of the lure body 20 from central axis A-A in a symmetrical manner, with the center 150 of the front concave surface being affixed on or near the longitudinal central axis of the lure body 20. This concave formed surface 130 of the cup member 120 causes the rear end of the fish lure 10 to dart about laterally in a splashing and popping, noisy motion, as caused by the interference of the front surface 130 of the cup shaped member with the hydrodynamic flow of the water over the lure body 20.

In some embodiment the cup member may be placed along other areas of the lure body to achieve the same affect, such as in the front of the lure. Moreover, in the embodiment shown in FIG. 1B, the cup shaped member 120 has a plurality of openings, 210A, 210B, 210C, 210D . . . intersperced over the cup member 120. These openings 210A, 210B, 210C, 210D . . . extend completely through the cup shaped member 120 from the front surface 130 to the rear surface of such cup member 120. These openings 210A, 210B, 210C, 210D . . . permits water streams to flow through such openings as the lure 10 is pulled through the water. The net result of the water stream passing through such openings causes a trailing protrusion of bubbles form the back of the lure as it passes through the water thus creating a more realistic resemblance of a small fish swimming in the water.

1: A fishing lure comprising of:
a) a longitudinally extending body portion said body portion having a head end and a posterior end, said longitudinally extending body portion having a longitudinally extending central axis and being shaped to be pulled under the water with said head end facing the direction of movement of the body portion;
b) a water flow inhibitor means affixed to a portion of the body portion adjacent said posterior end, said water flow inhibitor means being symmetrically positioned relative to said longitudinal central axis from a front end perspective with the center of said water flow inhibitor means being aligned with the longitudinally extending axis of said body portion of said water flow inhibitor means having a front concave surface facing towards said head end of said body portion.

2: A fishing lure comprising of:
a) a longitudinally extending body portion, said body portion having a head end and a posterior end, said longitudinally extending body portion being adapted to be pulled through the water with the head facing the direction of movement of the body portion;
b) a water flow inhibitor member comprising a cup member having a concave frontal face facing toward the front end of said body portion with said concave member having a plurality of openings therein to permit water to pass therethrough as said body portion is pulled through the water, said water flow inhibitor means being symmetrically positioned relative to said longitudinal central axis froth a front end perspective with the center of said water flow inhibitor means being aligned longitudinally extending axis of said body portion of said water flow inhibitor means having a front concave surface facing towards said head end of said body portion.
